(19) United States
(12) Patent Application Publication
(10) Pub. No.: US 2010/0217737 A1
(43) Pub. Date: Aug. 26, 2010

(54) Method and system for business rules management

(76) Inventor: Ajay Shama, Carol Stream, IL (US)

Correspondence Address: CLIFFORD H. KRAFT, 320 ROBIN HILL DR., NAPERVILLE, IL, 60540, US

(21) Appl. No.: 12/380,001

(22) Filed: Feb. 20, 2009

(51) Int. Cl. G06N 5/02

(52) U.S. Cl. 706/47; 706/59; 706/48

(57) ABSTRACT

computer software and method for managing business rules that can include creating a business rule and storing it on a disk or in a database or rule archive. The rules can be expressed in natural language, keywords, equations, or any other form. The invention also includes the ability to search for rules, edit rules and validate rules according to business various business rule patterns or predetermined validation criteria. As stated, rules can be created from keywords or expressed directly in natural language. There is no need to parse a rule for content since whether a rule can actually be coded can be decided by a coding group. Rules can be marked active or inactive and edited rules can be marked with version tracking. An optional feature of the invention is to send a message to everyone in an organization affected by a rule when it has been changed. Rules can be created and placed into one or more logical hierarchies organized in any arbitrary way including starting from an organization or company root node. The hierarchy can contain domains, packages and rules.

This application is related to and claims priority from U.S. Provisional patent application No. 61/066,053 filed Feb. 21, 2008. Application 61/066,053 is hereby incorporated by reference.

### BACKGROUND

1. Field of the Invention

The present invention relates generally to business management systems and more particularly to a method and system for creation and management of business rules.

2. Description of the Prior Art

Businesses operate through the use of numerous rules that coordinate day to day operations, management of financial information, management of data, management of personnel and many other aspects of business. Large businesses have historically had numerous divisions and departments, and in many cases, different divisions and different departments within a division have had different rules, many times different rules for managing the same type of information or processes.

Also, in many businesses, groups that write application software that implements business rules to provide business services that are separate from groups that generate business rules. In many cases, there is no way for groups with responsibility for rules to be sure that groups providing services had not modified the rules.

A business rule may be a set of steps that have to be followed in handling a particular type of transaction or it may be a set of constraints on a process. In general a business rule is created, disseminated to appropriate parties, saved where parties can access it, possibly later modified and possibly finally rescinded. In very small businesses, a business rule might be something as simple as a set of instructions written on a piece of paper by the company president or another manager that is distributed to appropriate departments. The problem with this is that there may be no formal record of the rule stored in a safe place or a place that can be accessed by other parties or other departments. Also, if multiple copies of the rule exist, revisions and updating may be very difficult. This can lead to some departments operating from an older version of a rule than others. In a large business with possibly hundreds or even thousands of business rules, the hand method becomes impossible.

A business rule may also have child business rules that are derived from it. These child rules may contain further constraints that apply to smaller and smaller segments of the business. For example, there might be a business rule that specifies that incoming orders are to be entered into the company's database in a certain way; however, different departments may have to enter the order differently from one another or with additional specific information. A west cost branch made need to enter order information with local information that is different from a similar order in an east coast branch. This leads to the west coast branch and the east coast branch having different versions of the rule. A simple way to support this is to have a master rule for the procedure with separate child rules for the west and east coast branches. The child rules inherit the basic rule, and then enhance it with particular sub-rules.

Business rules must be organized and stored in a way so that members of the organization can create rules, access rules, edit rules, trace rules and delete obsolete rules. It would be advantageous to have a system that allowed a flexible rule creation process, used standard rule pattern definitions, used simple language with no technical jargon to manage rules, characterized rules into domains, projects and packages that can be hierarchical, convert rules into language constructs such as object constraint language (OCL), provide rule traceability to business process models and business services as well as business and system requirements, enterprise services and legacy components and allowed advanced search and flexible rule reporting.

### SUMMARY OF THE INVENTION

The present invention relates to computer software and a method for managing business rules that can include creating a business rule and storing it on a disk or in a database or rule archive. The rules can be expressed in natural language, keywords, equations, or any other form. The invention also includes the ability to search for rules, edit rules and validate rules according to business various business rule patterns or predetermined validation criteria. As stated, rules can be created from keywords or expressed directly in natural language. There is no need to parse a rule for content since whether a rule can actually be coded can be decided by a coding group. Rules can be marked active or inactive and edited rules can be marked with version tracking. An optional feature of the invention is to send a message to everyone in an organization affected by a rule when it has been changed. Rules can be created and placed into one or more logical hierarchies organized in any arbitrary way including starting from an organization or company root node. The hierarchy can contain domains, packages and rules.

### DESCRIPTION OF THE FIGURES

Attention is directed a particular illustrations to aid in understanding the present invention:

FIG. 1 shows a block diagram of an embodiment of the present invention.

FIG. 2 shows a hierarchy of organization, domain, package and rule.

FIG. 3 shows parent-child relations.

Several drawings and illustrations have been presented in order to clarify understanding of the invention. The scope of the present invention is not limited to what is shown in the figures.

### DESCRIPTION OF THE INVENTION

The present invention relates to a method and system for business rule creation and management that can run on a computer system using various databases. The computer system or network wherein the executable software runs generally has one or more memory devices like random access memory, hard disks, flash memory, CDROMs, DVDs and the like. The executable programs of the present invention allow the creation, editing, searching and management of business rules as well as validation of rules based on business rule patterns. Rule patterns are rule categories or rule types with pre-defined constructs that can assembled as rule segments and key words. Rules and rule patterns can be expressed in natural language. The present invention also allows creation of rules that go beyond pre-defined patterns and are entirely expressed by natural language.

The present invention allows searching of business rules based on rule names, packages, domains, patterns or on the words contained in particular rules. The present invention allows rule visibility that leads to rule traceability to a business process model, to a business or system requirement, to enterprise services and to legacy components or computer programs where the rules are applied or implemented.

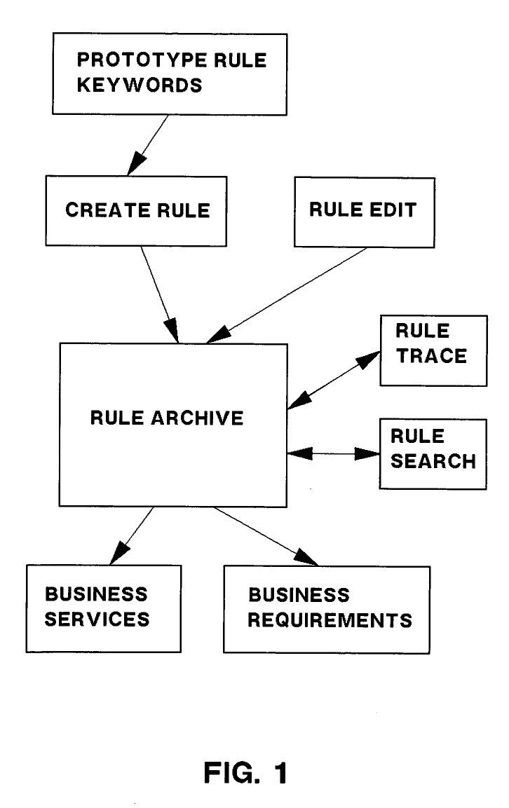

FIG. 1 shows a block diagram of an embodiment of the present invention. A rule creation and editing block can be used to create new rules and edit old ones. Rules can be entered into a rule archive. A store of prototype rules or rule keywords can be used to help in the rule creation process. To create a rule, prototype keywords can be made part of the current rule. A rule can be constructed from keywords using a natural language construct or can be totally constructed from natural language without any particular keywords. The present invention is concerned with creating, maintaining, presenting and tracing business rules. In general, it is not necessary to formally parse a rule (or to verify that it makes sense). Because of this, it is not necessary to have a formal rule syntax that has to be followed. While the present invention allows formal syntax structures to be used, the user is not constrained to follow them.

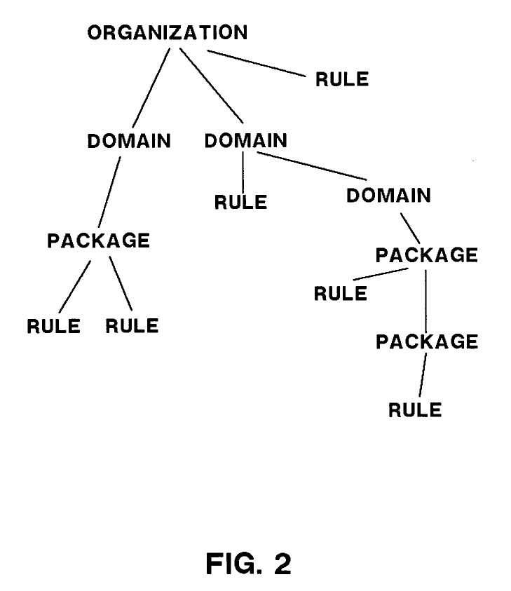

Generally, a business rule belongs to an organization, a rule domain and a particular rule package as shown in FIG. 2; however, a rule may be in any one of these entities directly. An organization is an enterprise such as a company or division such as an insurance company, a domain can be an aspect of the business such as, in the case of the insurance company, domains might be providers, claims processing, payers, etc. Domains generally have particular owners. A package may be a particular folder belonging to one of the domains. For example, a claims processing domain may have different packages for medical claims, dental claims, etc. The hierarchy can be defined by the following set of rules:

1) An organization may have domains, packages and/or rules.

2) A domain may have domains, packages and/or rules.

3) A package may have packages or rules.

4) A rule may have child rules.

The process may start with only a root node that represents an organization or enterprise. A new rule domain may be added to the organization, a new package may be added to the domain that may represent a project and a new rule may be added to the package. However, when a rule applies across domains, it may be added to the organization, or if it applies across packages, it may be added to a domain. Usually however, rules belong to specific packages.

Features of the present invention allow complete reorganization of the relationships between a particular rule, rule packages and rule domains. For example, a rule created in one package or domain or in the organization can be moved to any other package or domain. Packages can be moved from one domain to another or to the organization. The rule editor feature of the present invention generally allows any change in a rule and any change in the hierarchical arrangement of rules, domains or packages according to the above rules. Security features can assure that only personnel who are authorized are allowed to make such edits or changes.

A rule that is used across different packages generally belongs to a domain that contains the packages. A rule that is used across different domains generally belongs to the organization or to a domain that contains other domains.

To create a new business rule, a user can enter the rule in a natural language format using the rule creation feature shown in FIG. 1. In some embodiments of the invention, after the user types a particular word, a list of possible next words pops up. This is called intelligent typing known in the art. If the user uses one of these particular next suggested words, the process proceeds. As the rule is generated using suggested words, a logic chart of the rule can be generated. At any time however, the user can deviate from suggested next words. At that point, the charting normally stops, and the rule can be entered from that point on in any form the user wants (freeform). Rules can take any logical form. Examples of business rules are: “Price=Cost+Tax”, or “After receiving claim, wait 30 days before sending payment”. Any rule that can be expressed in natural language is within the scope of the present invention. It is not necessary that a rule obey some predetermined syntax, be parsable or even make sense for the present invention to handle it. Of course if a rule does not make sense or is ambiguous, it may be impossible for an application group to successfully code it into an application.

In addition to allowing rules to be edited and modified, the present invention allows rules to be marked as active or inactive. This allows archiving and tracking of changed or superceded rules and version control. If a rule is changed, the newer version of the rule is generally marked as active, while previous versions can be kept and marked inactive. Only one version of a rule can be active; however, any selection can be made as to which version is currently active. This feature allows traceability of how a particular rule has been modified, when and by whom. An updated version of a rule might be: Net Price=Base Price+Sales Tax where the older version was Net Price=Base Price+Tax. This newer version of the rule can be marked active while the previous version can be marked inactive. At any time, authorized persons may change the status of any active or inactive rule as long as only one version is active.

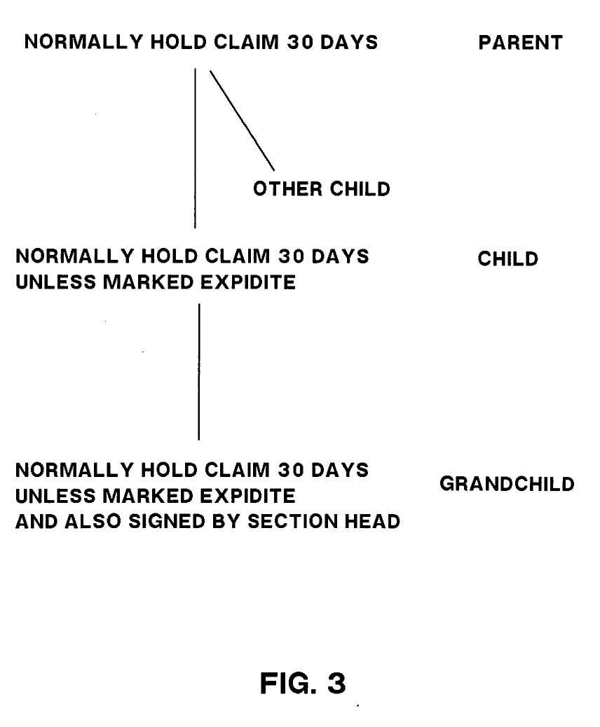

Rules may be derived from other rules in a parent-child relationship with the child rule inheriting properties from the parent as shown in FIG. 3. A parent rule may be of a particular form. For example, a parent rule might be Net Profit=Base Price+Tax. A child rule would start out this way. The child rule might be modified to Net Profit=Base Price+Tax−Commission. Generally, there can be only one parent rule for any given rule; however, a given rule may have multiple child rules derived from it. Thus the parent-child relationship forms a tree structure. As another example, in an insurance company, medical claims may come from professionals (doctors) or institutions (hospitals). There may be a parent rule for handling a medical claim; however, there may be slightly different versions of this medical claim rule depending on whether its source was professional or institutional. An example of a such a difference might be the length of time allowed for payment.

The present invention allows searching and tracing. Searchable information can be stored along with a particular rule. For example, A rule may have a parent type, parent name, a rule name and a rule description associated with it along with many other possible fields. Each of these fields can be searched by advanced search methods. Rules can also be searched as to domain, package, and by business service. Since a business service is an actual application based on the rule, it represents the rule actually being used. A rule could be used as a key to search for what business services it is used in (this is more properly called a trace), or a business service could be searched to see what rules it is using. Any type of searching on any data parameter is within the scope of the present invention.

As stated, the present invention also allows tracing of business rules. This feature provides information about where a rule is a applied in business processes or business services. In an organization, a particular business rule may be applied to several different business processes, and when a particular rule changes, trace information will show the impacted business processes. Traceability information normally must be entered by a user of the present invention as a particular rule is applied to a particular business process or business service.

In some organizations, requirements for actual applications may be generated by a requirements group. This group generally bases requirements on rules generated by groups responsible for rule generation. As requirements for a new application progress, the requirements group may access one or more rules from a rule archive. Each rule accessed can be given to the requirements group as a copy that is either read-only, or that can be changed. In the case of inflexible rules, a read-only copy can be supplied. More common, a writeable copy is provided. If the requirements group changes the copy (modifying the rule for their application), feedback can be provided by daemons or other methods to persons responsible for maintaining rules. The changed rule copy may optionally be saved back in the archive as a new rule or a child rule of the original rule. Different organizations may handle this differently. Any method of supplying rules to a requirements group and of handling changed copies of rules is within the scope of the present invention.

As previously stated, business services are actual applications that are based on rules. Ideally, all services should be traceable back to a rule or set of rules. Since rule creation and management is usually the responsibility of different people than those responsible for particular business services, the news of a change in a rule may not reach one of the particular business services that is based on that rule. The present invention provides a formal communication method to flag when a particular rule has changed and to send a message to each business service using that rule. One way to implement this communication in a particular business is to send electronic mail (email) to a designated person for a particular business service when a rule change affects that business service. Any other communication method is within the scope of the present invention. Also, the affected business service can flagged so that, when a rule changes, all business services affected can be identified to the person changing the rule.

Several descriptions and illustrations have been presented to aid in understanding the present invention. One skilled in the art will realize that numerous changes and variations are possible without departing from the spirit of the invention. Each of these changes and variations is within the scope of the present invention.

I claim:

1. A method for managing business rules running executables on a digital computer having a memory device;
creating a business rule and storing said rule in said memory device, wherein, said business rule can be expressed in natural language;
searching for said business rule on said memory device;
editing said business rule by retrieving it from said memory device, changing it and re-storing it on said memory device;
validating said business rule on said memory device according to predefined business rule patterns.

2. The method of claim 1 further comprising entering said business rule into a rule archive on a memory device.

3. The method of claim 1 further comprising using a prototype ruled stored on said memory device while creating said business rule.

4. The method of claim 1 wherein said rule can be constructed from keywords.

5. The method of claim 1 wherein said rule can be constructed totally from natural language.

6. The method of claim 1 further comprising entering said business rule into a rule hierarchy stored on a memory device.

7. The method of claim 6 wherein said hierarchy starts with a root node.

8. The method of claim 1 wherein said rule can be marked active or inactive on said memory device.

9. The method of claim 1 wherein said rule may have search and trace information stored along with it on said memory device.

10. The method of claim 1 wherein said search and trace information is chosen from the group consisting of parent type, parent name, rule name, domain, package, business service and rule description.

11. The method of claim 1 further comprising sending a message to each business service using said rule when said rule is changed.

12. A method for managing business rules running executables on a digital computer having a plurality of memory devices;
creating a business rule and storing said rule on one of said memory devices, wherein, said business rule can be expressed in natural language;
searching for said business rule on one of said memory devices;
editing said business rule by retrieving it from one of said memory devices, changing it and re-storing it on one of said memory devices;
validating said business rule on one of said memory devices according to predefined business rule patterns;
entering said business rule into a rule hierarchy stored on one of said memory devices;
marking said rule active or inactive on one of said memory devices.

13. The method of claim 12 further comprising using a prototype ruled stored on one of said memory devices while creating said business rule.

14. The method of claim 12 wherein said rule may have search and trace information stored along with it on one of said memory devices.
